(19) United States
(12) Patent Application Publication
(10) Pub. No.: US 2016/0335360 A1
(43) Pub. Date: Nov. 17, 2016

(54) SYSTEM AND METHOD FOR DETERMINING SUITABLE NETWORK PATHS

(71) Applicant: INFLUITIVE CORPORATION, Toronto (CA)

(72) Inventors: Frank FALCONE, Toronto (CA); Sina SHAHANDEH, East York (CA)

(21) Appl. No.: 15/154,513

(22) Filed: May 13, 2016

Related U.S. Application Data
(60) Provisional application No. 62/160,859, filed on May 13, 2015.

(51) Int. Cl. G06F 17/30

(52) U.S. Cl. CPC G06F 17/30867; G06F 17/3053; G06F 17/30377; G06F 17/30958

(57) ABSTRACT

Finding user profiles in a computer system includes updating a graph database by referencing a user profile database that stores user profiles and that defines relationships among the user profiles. Each user profile contains data about a user. The graph database represents the user profiles as nodes and represents relationships among the user profiles as edges. Connection properties are assigned to edges between pairs of nodes of pairs of respective users profiles of respective users based on communications events between the respective users and contact information shared between the respective users. A total connection value is calculated for a path of edges between a searching node associated with a searching user profile and a target node associated with a target user profile. An intermediate node connected to edges of the path is selected and an indication of an intermediate user profile associated with the intermediate node is outputted.

### CROSS-REFERENCE TO RELATED APPLICATIONS

This application claims the benefit of U.S. 62/160,859, which is incorporated herein by reference.

### FIELD

This disclosure relates to computer networks, more specifically, to computerized social data systems.

### BACKGROUND

Computerized social networks are widely known. Some social networks are designed for personal social circles, while others are designed for career-related relationships. Most, however, suffer from various disadvantages.

Most social networks were constructed to facilitate convenient computer-based connections among people who already know each other in real life. An individual may initiate transmission of a digital request message to another individual that they know outside of the network. The second individual may respond with a digital response message confirming the existing relationship and consenting to establishing a computerized relationship within the social network.

This methodology does not transpose well when a social network user wishes to connect with another user that they do not know or do not know well in real life. What frequently happens in such situations is that the user sends a digital request message to the individual with whom they wish to establish a new computerized relationship, and that individual often ignores the unknown request. The first user may then send digital request messages to other users, who already have computerized relationships with the desired individual, and each of these users may also ignore the first user's request or respond negatively or with deferrals using digital response messages. Ultimately, the seeking user may need to send a large number of digital request messages and receive a large number of digital response messages before finally, perhaps, establishing a computerized relationship with the desired individual.

This inherent technical problem with how computerized social networks are designed and structured results in the waste of computer resources, in the form of digital requests/responses that achieve no result or no change of state within the network. Further, users become dissatisfied with the social network, in that the network appears to not function well due to the many digital requests/responses required to establish a new computerized relationship and/or due to the lack of functionality specifically structured to improve the process of establishing new computerized relationships.

### SUMMARY

According to an aspect of the present invention, finding user profiles in a computer system includes updating a graph database by referencing at least one user profile database that stores a plurality of user profiles and that defines relationships among the plurality of user profiles. Each user profile contains data about a user. The graph database represents the plurality of user profiles as nodes and represents relationships among the plurality of user profiles as edges. Connection properties are assigned to edges between pairs of nodes of pairs of respective users profiles of respective users based on at least one of a communications event between the respective users and contact information shared between the respective users. At least one total connection value is calculated for a path of edges between a searching node associated with a searching user profile and a target node associated with a target user profile. An intermediate node connected to edges of the path is selected and an indication of an intermediate user profile associated with the intermediate node is outputted.

Advantageously, the searching user can contact the user of the intermediate user profile to facilitate an introduction to a target user associated with the target user profile, thereby eliminating or reducing the number of digital requests/responses needed.

Other aspects and advantages of the present invention are discussed in detail below and represented in the claims.

### BRIEF DESCRIPTION OF THE DRAWINGS

The drawings illustrate, by way of example only, embodiments of the present disclosure.

FIG. 1 is a diagram of a social networking computer system.

FIG. 2 is a schematic diagram of a user profile database.

FIG. 3 is a schematic diagram of a graph database.

FIG. 4 is block diagram of a profile system.

FIG. 5 is a flowchart for an adding process.

FIG. 6 is a flowchart for updating and querying processes.

FIG. 7 is a diagram showing example paths and determination of a best path.

FIG. 8 is a diagram of indications of intermediate users.

FIG. 9A is a table of example contact information weights.

FIG. 9B is a table of example communications weights.

FIG. 10 is a schematic diagram of a machine learning system.

### DETAILED DESCRIPTION

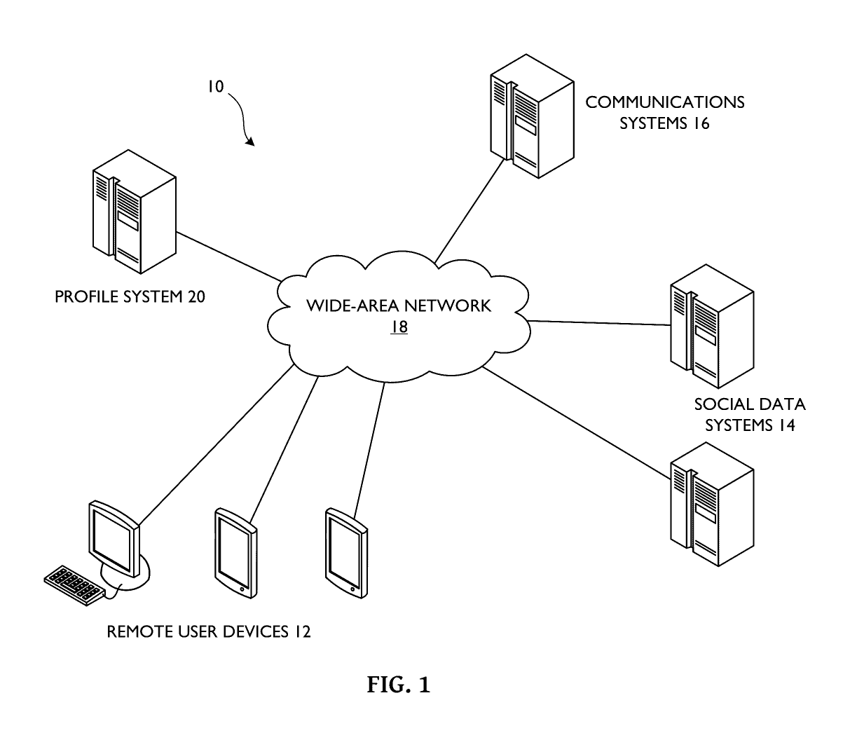

FIG. 1 shows a social networking computer system 10 according to the present invention. The social networking computer system 10 includes a plurality of remote user devices 12, one or more social data system 14, one or more communications systems 16, a wide-area network 18, and a profile system 20. The social networking computer system 10 may include further components, which are omitted for sake of clarity.

The plurality of remote user devices 12 include devices such as smart phones, tablet computers, desktop/notebook computers, smart watches, and similar. Each remote user device 12 allows an operating user to connect various computer systems available via the network 18. Remote devices 12 may execute specialized applications (“apps”) to communicate with various computer systems, may execute a generic user agent (e.g., web browser) to communicate with various computer systems, or may perform a combination of such.

The social data systems 14 include servers and other devices operated by various computerized social networks, such as LinkedIn™, Facebook™, Twitter™, and similar. Each social data system 14 stores profiles about users, such as the user operating the remote devices 12, as well as relationships among such users. Each social data system 14 can include a user profile database that stores such user profiles and that defines such relationships among the plurality of user profiles. The term “database”, as used in this disclosure, is not limited to a single database and can denote a plurality of cooperating databases, distributed database(s), a data store, and similar.

The communications systems 16 are configured to communicate electronic messages among users of the remote devices 12. Examples of communications systems 16 include email systems (e.g., Gmail™, Yahoo Mail™, etc.), instant messaging systems, short-message service (SMS/MMS) systems, and similar. The remote devices 12 connect to the communications systems 16 using accounts and credentials of the users. The communications systems 16 facilitate communications events among users of the remote devices 12. Each communications system 16 provides each user with their own contact information for that system 16.

Various social data systems 14 and communications systems 16 may have overlapping functionality and these systems need not be separate and distinct. For instance, a social data system 14 may provide instant messaging functionality, or an email service may offer social network functionality to its subscribers. The social data systems 14 facilitate communications events among users of the remote devices 12. Each social data system 14 provides each user with their own contact information for that system 14.

The profile system 20 is a separate and distinct system that includes at least one user profile database that stores a plurality of user profiles and that defines relationships among the plurality of user profiles. Each user profile contains data about a user of a remote device 12. The profile system 20 also includes a graph database representing the plurality of user profiles as nodes and representing relationships among the plurality of user profiles as edges. The graph database is based on the user profile database. Alternatively, the profile system 20 does not include a user profile database and the graph database is based on one or more user profile databases of one or more social data systems 14. Other data storage structures similar to a graph database may be used instead of or in addition to the graph database.

The profile system 20 can be configured to query the social data systems 14 and communications systems 16 to build and update the user profile database based on responses to such queries. The profile system 20 can be responsive to indications or permissions from the remote devices 12 that instruct or permit the profile system 20 to collect data from the systems 14, 16 and create and update user profiles based on such data. That is, each user of a remote device 12 can allow the profile system 20 to gather data from the user's various social network accounts. The profile system 20 can be configured to maintain a unique user profile for each user, regardless which systems 14, 16 store data about the user. The profile system 20 can be configured to continually harmonize and de-duplicate user profiles.

The graph database stores connections among users, and the profile system 20 is configured to find user profiles based on the graph database. Particularly, the profile system 20 is configured to find people who can make introductions to unknown people with whom contact is desired. For instance, Tom may wish to contact Mary but does not know Mary. The profile system 20 can determine which of Tom's contact are appropriate to make a successful introduction to Mary or to someone in a path of contacts towards Mary. The profile system 20 uses the graph database to facilitate introductions in a fast and resource-efficient manner.

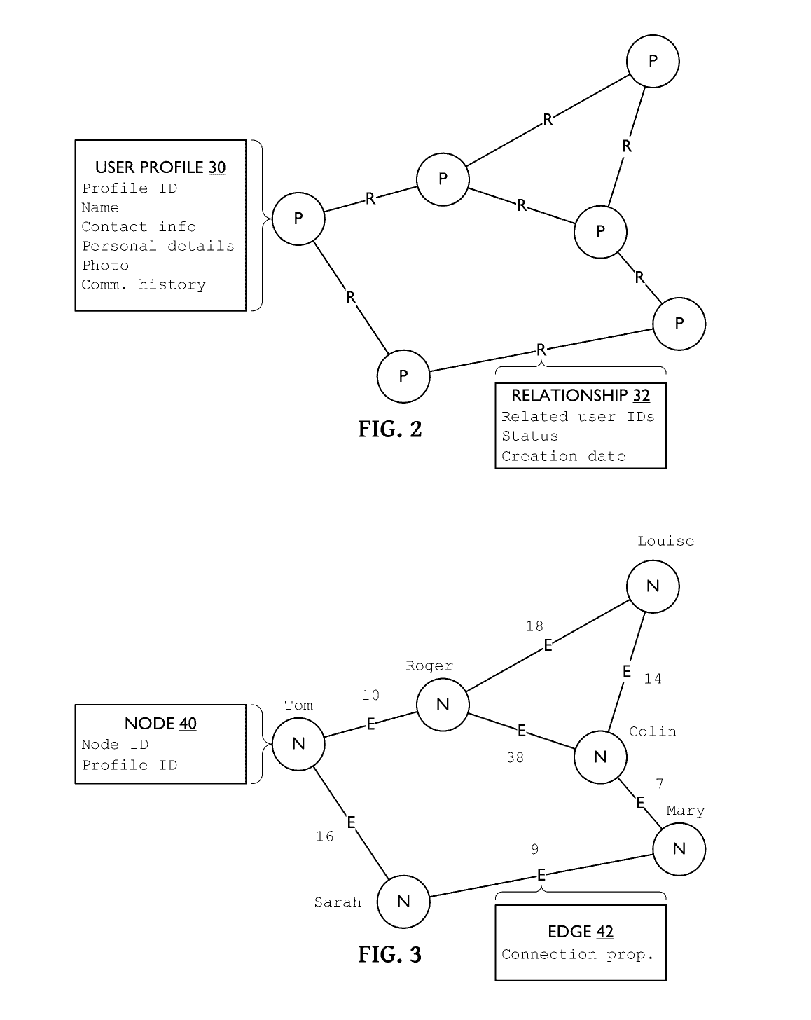

FIG. 2 shows a schematic diagram of a user profile database, and particularly the user profile database of the profile system 20. Profiles P of various users are related to other profiles P of other users via relationships R. User profile data 30 stores information and/or references to information such, for example, as name, contact information, personal details (e.g., age, gender, etc.), job title, income, demographic details, photos, communications history data, and similar. Contact information includes items such as email addresses, phone numbers, instant messaging addresses, physical addresses, and similar. Communications history data includes counts of communications events between a user associated with a user profile and other users associated with other user profiles. Counts of communications events can include counts of various kinds of incoming and outgoing messages, such as email messages and SMS messages, as well as counts of incoming and outgoing phone calls. Counts of communications events can include counts of social media actions, such as messages, posts, likes, shares, and similar. Counts of communications events can include counts can include counts of other actions in the system 10.

Relationships R among user profiles P include relationship data such as, for example, relationship status, relationship creation date, and similar.

The user profile database can be implemented as a relational database or similar.

FIG. 3 shows a schematic diagram of the graph database of the profile system 20. The graph database represents the plurality of user profiles P of the user profile database as nodes N and represents relationships among the plurality of user profiles as edges E. Each node 40 stores a profile identifier (ID) to relate back to the respective user profiles of the user profile database. Each edge 42 stores at least one connection property that is indicative of the level of connectedness between users represented by the connected nodes N. Each node N can be connected by two edges E, one edge representing connectedness in one direction and the other edge independently representing connectedness in the other direction. That is, Tom may have high connectedness to Roger, while Roger may have lower connectedness to Tom.

The profile system 20 can use the connection properties of the edges E to quickly and efficiently query the graph database calculate total connection values for paths between a searching user and a target user, so as to find intermediate users between the user who is searching for a way to contact the target user, where such intermediate users may be suitable to introduce the searching user to the target user or to someone closer to the target user. It is contemplated that such intermediate users are directly connected to the searching user and may be directly connected to the target user or may be connected to the target user via one or more other intermediate users.

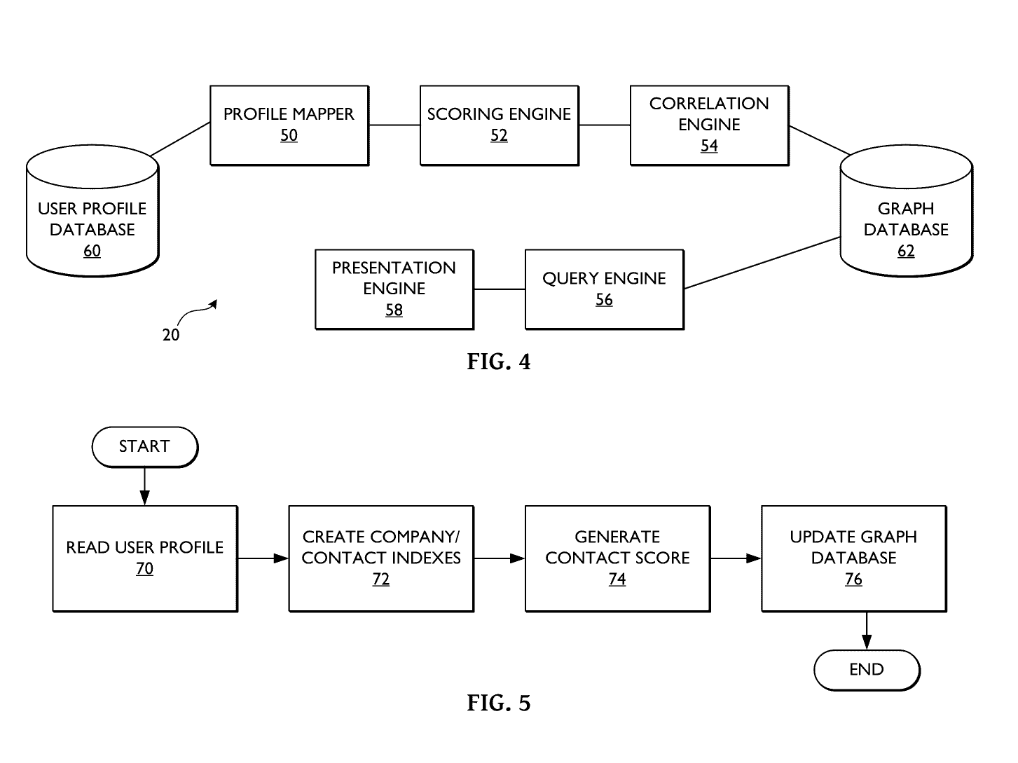

FIG. 4 shows the profile system 20. The profile system 20 can be implemented on a server, a group of servers, or any other computer system that includes at least one processor for executing programs, memory for storing programs and data, and a communications interface for communicating data via the network 18. The profile system 20 can include a profile mapper 50, a scoring engine 52, a correlation engine 54, a query engine 56, and a presentation engine 58. The profile system 20 further includes the graph database 62. The profile system 20 can further include the user profile database 60.

The profile mapper 50 is connected to the user profile database 60 and is configured to correlate and clean user profiles to try to maintain one unique user profile per person.

The scoring engine 52 is connected to the profile mapper 50 and is configured to calculate connection properties among user profiles based on communications events between pairs of users (engagement) and contact information shared between pairs of users (relationship).

The correlation engine 54 is connected to the scoring engine 52 and the graph database 62 and is configured to build and update edges between nodes and assign connection properties to the edges.

The query engine 56 is connected to the graph database 62 and is configured to calculate total connection values among nodes of the graph database 62. A total connection value can be calculated by totalling connection properties for edges that connect two nodes in a particular direction and via one or more intermediate nodes. For example, with reference to FIG. 3, if Tom wishes to be introduced to Mary, the query engine 56 queries the graph database 62 and calculates total connection values for the various paths of edges from Tom to Mary. Path 1 is from Tom to Roger to Louise to Colin and to Mary and has a total connection value, in that direction, of 10+18+14+7=59. Path 2 (Tom-Roger-Colin-Mary) has a total connection value of 55, while path 3 (Tom-Sarah-Mary) has a total connection value of 25.

The presentation engine 58 is connected to the query engine 56 and is configured to output one or more indications of one or more intermediate user profiles associated with one or more intermediate nodes along paths from a searching user (e.g., Tom) to a target user (e.g., Mary). The profiles indicated can be selected based on the calculated total connection values, such that one or more users connected to the searching user are suggested as the first step in contacting the target user. Continuing the above example, the presentation engine 58 can output to Tom indications of Roger (59) and Sarah (25) meaning that an introduction to Mary may be better made by asking Roger because the relationship paths via Roger indicate closer, stronger, or more actively maintained personal/professional relationships.

FIG. 5 shows a flowchart of a process for adding a relationship to the profile system 20. At step 70, a user profile is read and relevant data is extracted. A new node can be identified. At step 72, relationships between the user profile and existing user profiles are determined. New edges can be identified. At step 74, values or scores for various relationships with the user profile can be determined. Connection properties can be identified. At step 76, the graph database 62 can be updated to add the new node, edges, and connection properties.

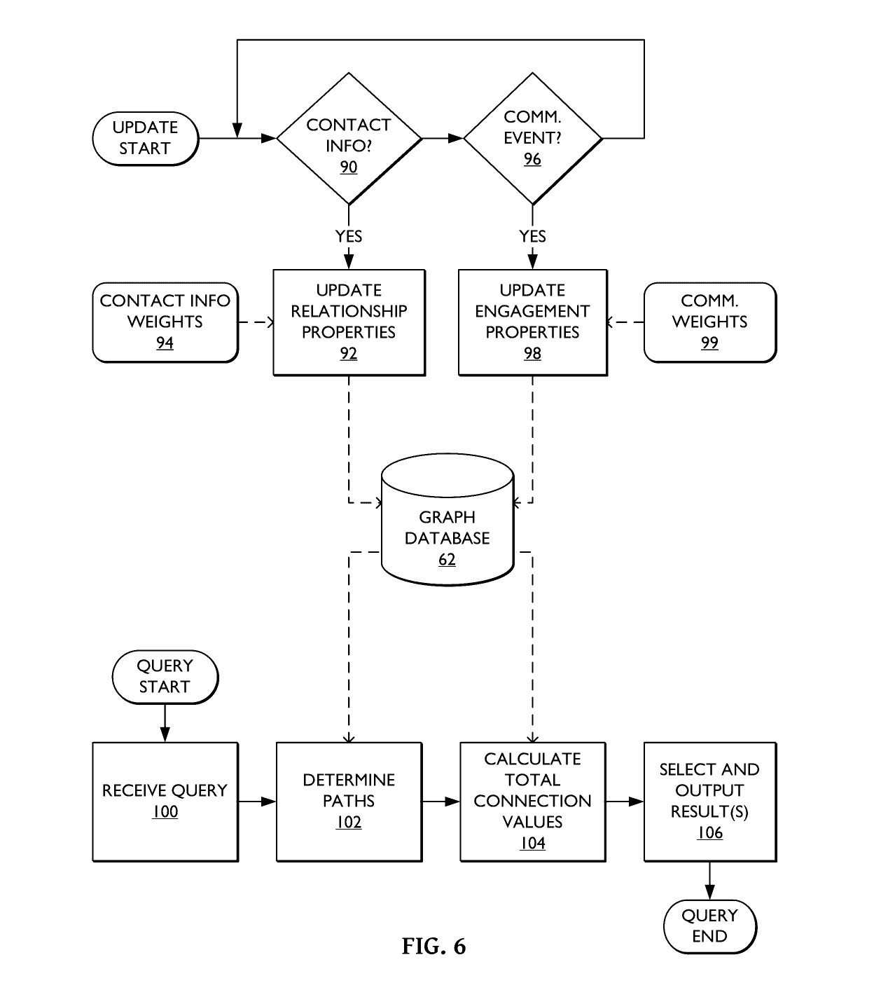

FIG. 6 shows independent and asynchronous processes for updating the graph database 62 and querying the graph database 62.

The update process assigns connection properties to edges between pairs of nodes of pairs of respective users profiles of respective users based on at least one of a communications event between the respective users and contact information shared between the respective users. The update process will be described in terms of a particular user, but it should be understood that the process can be performed for a plurality of users.

At step 90, new or changed contact information of another user is detected in the particular user's profile. Then, step 92 calculates one or more relationship properties for the relevant user profiles with reference to different contact information weights 94 assigned to different types of contact information, and updates the associated connection property in the graph database 62. Contact information that is more personal is given higher contact information weights 94 to indicate a closer relationship. A given relationship property can be the sum of each element of contact information multiplied by its respective weight.

At step 96, a communications event between the particular user and another user is detected. Then, step 98 calculates one or more engagement properties for the relevant user profiles with reference to different communications weights 99 assigned to different types of communications events, and updates the one or more associated engagement properties in the graph database 62. Communications events that are more personal can be given higher communications weights 99 to indicate a closer relationship. A given engagement property can be the sum of each instance of a communications event multiplied by its respective weight. The summation may also take other factors into account. Whether or not communications event is a reciprocal event may provide an increased weighting. Recency and a cut-off time can be considered, in that older communications events have reduced contribution and communications events older than a certain time do not contribute at all. Additionally, a count of other parties to the communications event can be considered, in that one-to-one communications events are weighted more than one-to-many events.

The update process can be performed periodically, as triggered by changes to contact information, as triggered by detection of new communications events, each time a new users joins the profile system 20, on a combination of such, or similar.

The query process calculates total connection values for paths between a searching user and a target user and selects one or more intermediate users, known to the target user, based on the total connection values. The query process outputs indications of the one or more intermediate users to the searching users as indications of who can facilitate an introduction to the target user.

At step 100, a query is received from a searching user. The query indicates a target user who the searching user would like to be connected to. Next, at step 102, paths from the searching user to the target user are determined using the graph database and nodes representative of the searching user, the target users, and intermediate users there-between. At step 104, total connection values are calculated for the paths based on connection properties of the edges, such as the relationship properties and/or the engagement properties discussed above. Then, at step 106, total connection values are compared (to each other and/or to a threshold), while taking into consideration path length if desired, to obtain at least one or more intermediate users directly connected to the searching user, and indications of such intermediate users' profiles are output to the searching user.

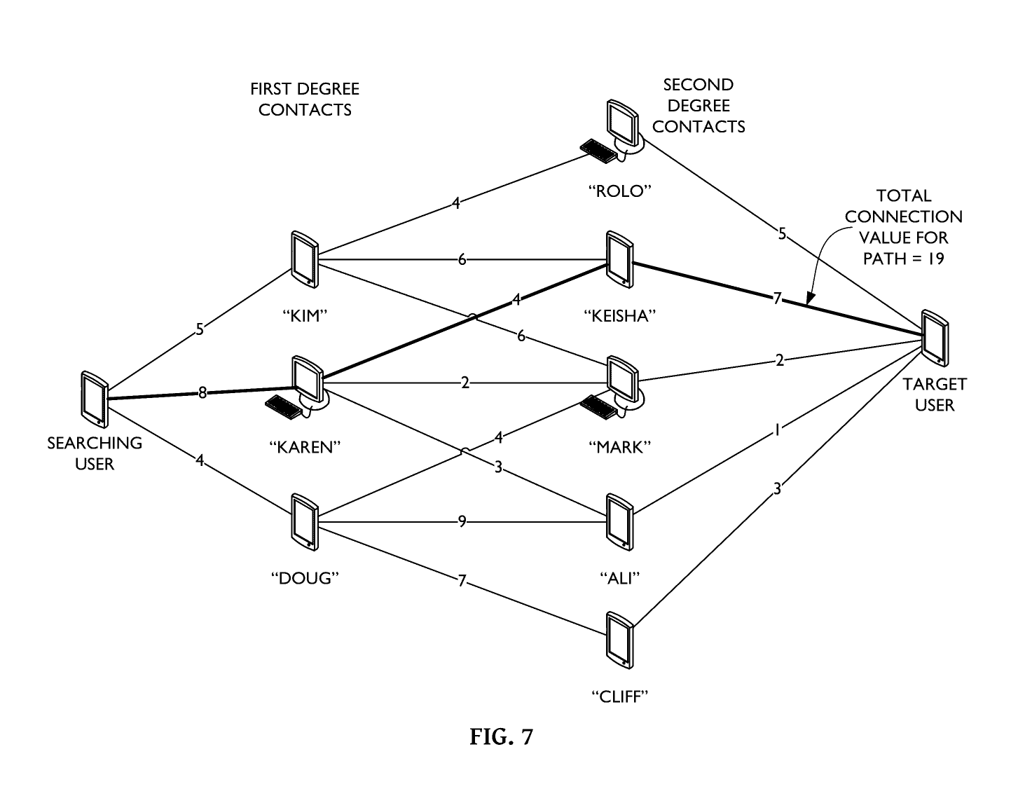

It is contemplated that the comparison of paths to select one or more intermediate users can be performed in various ways taking into account total connection values, path lengths, or a combination of such. Total connection value can be maximized while path length is minimized. Total connection value can be blended with path length, such that longer paths reduce the total connection value. Total connection values can only be considered for certain path lengths (e.g., 2 or 3 edges or degrees of separation). Total connection values and path lengths can be filtered by thresholds. Any of these techniques can be used in combination, and further techniques are also contemplated. Using such techniques, the comparison of paths selects the one or more “best” intermediate users for the searching user to contact for an introduction to the target user. FIG. 7 shows an example with various paths and connection values, as well as an example selection of a best path (in bold line), its total connection value, and a most suitable intermediate user (“Karen”) to initiate the introduction.

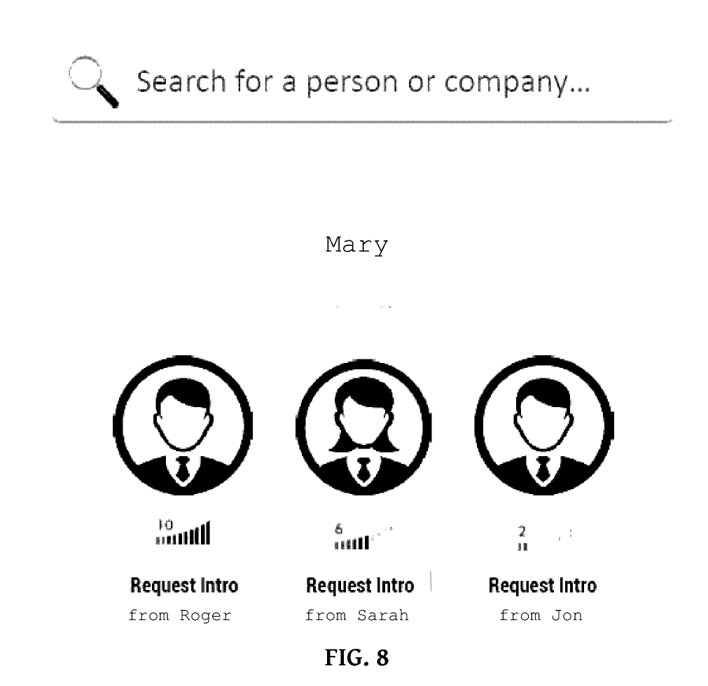

FIG. 8 shows an example of output to the searching user. Indications of intermediate users, such as photos, pictures, names, icons, and/or similar, directly connected to the searching user can be displayed in association with indications of the respective total connection values, which can be expressed graphically, as normalized values, as text/graphic labels, or in another way. A button or other user interface element can be provided for each intermediate user to initiate an introduction to the target user. Any number of intermediate user indications may be shown and such number may be predetermined (e.g., 3, as illustrated) or may be calculated as dependent on, for example, total connection value, path length, or similar factors. In some examples, all possible intermediate users are indicated.

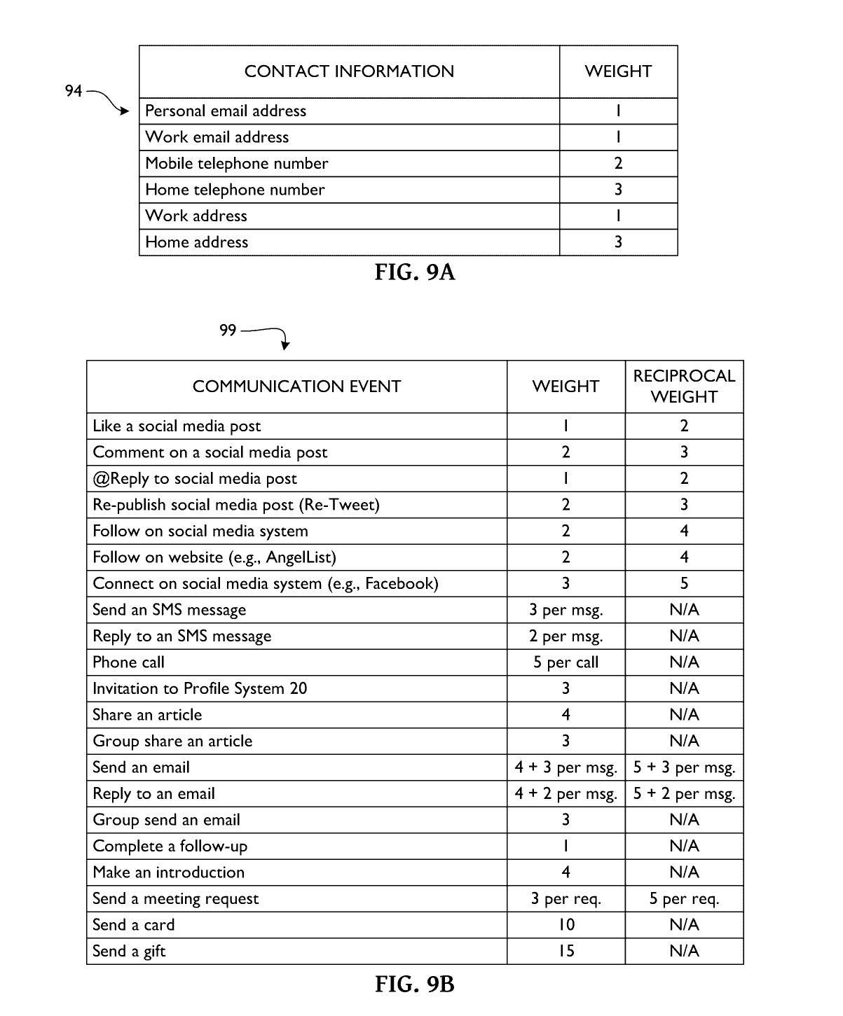

FIG. 9A shows examples of contact information weights 94 assigned to different types of contact information, discussed with respect to FIG. 6. As can be seen, contact information that correlates to stronger relationship, such as home telephone number, can be weighted greater than other contact information, such as a work email address, which may be disclosed by the intermediate/target contact more readily.

FIG. 9B shows examples of communications weights 99 assigned to different types of communications events, discussed with respect to FIG. 6. Types of communications that represent a stronger relationship, such as meeting requests, can be weighted greater than other types of communications, such as emails. Moreover, the direction of such communications, whether to or from (reciprocal) the intermediate/target contact, can be reflected in the weightings, with inbound communications received by the particular user from the intermediate/target contact representing a stronger relationship with the particular user and therefore weighted higher. For a particular type of communications event, the communications weights 99 can be singular, computed based on a linear relation, or computed based on a non-linear relation. A singular weight can be used for a type of event that occurs (or reoccurs) only once during the relationship between two users. Examples of such events include following on a particular social network, inviting to a service (such as the profile system 20), and similar. A weight based on linear relation can be used for communications events such as email, SMS messages, and meeting requests, in that each instance of the event increase the weight with or without a baseline weight. A weight based on non-linear relation can be used for similar communications events and may increase or decrease at a changing rate.

Recency and a cut-off time can be modelled according to the equation below, such that older communications events have reduced contribution to a total connection value and communications events older than a certain time do not contribute at all.

$${E}_{n} = {\sum }_{d = 0}^{n} {S}_{d} ( 1 - \frac{d}{n} )$$

where

Eₙ is a total connection value over a time of n days,

n is the number of days (e.g., 90), which may be user-configurable,

d is the amount of days from the current day, counting backwards (e.g., 0 is today, 1 is yesterday, etc.),

S_{d} is the total connection value accumulated for the given day, and

d/n represents the linear decay of communications events as time, d, goes to n. Alternatively, Non-linear decays, such as logarithmic decays, may be used.

The above equation may apply to all communications events for the particular user. Alternatively, several different equations (with different decays, constants, or similar) may be used for several different classifications of the user's contacts. That is, an equation for family member contacts may have a slower rate of decay and a minimum value, whereas an equation for acquaintance contacts may have a faster rate of decay and zero minimum.

A total connection value may be indicated in a user interface as a label or other “soft” value, as opposed to a numerical result from the equation. The mean total connection value over the given time may be computed as follows:

A=Eₙ/n

A label for the total connection value may then be taken from the following mapping relationship:

| | |
|---|---|
| A <= 0.15 | Cold |
| 0.15 < A <= 0.40 | Neutral |
| 0.40 < A | Warm |

Thus, a user-informative label can be displayed to a user as text or graphic to generally indicate the total connection value for a particular contact.

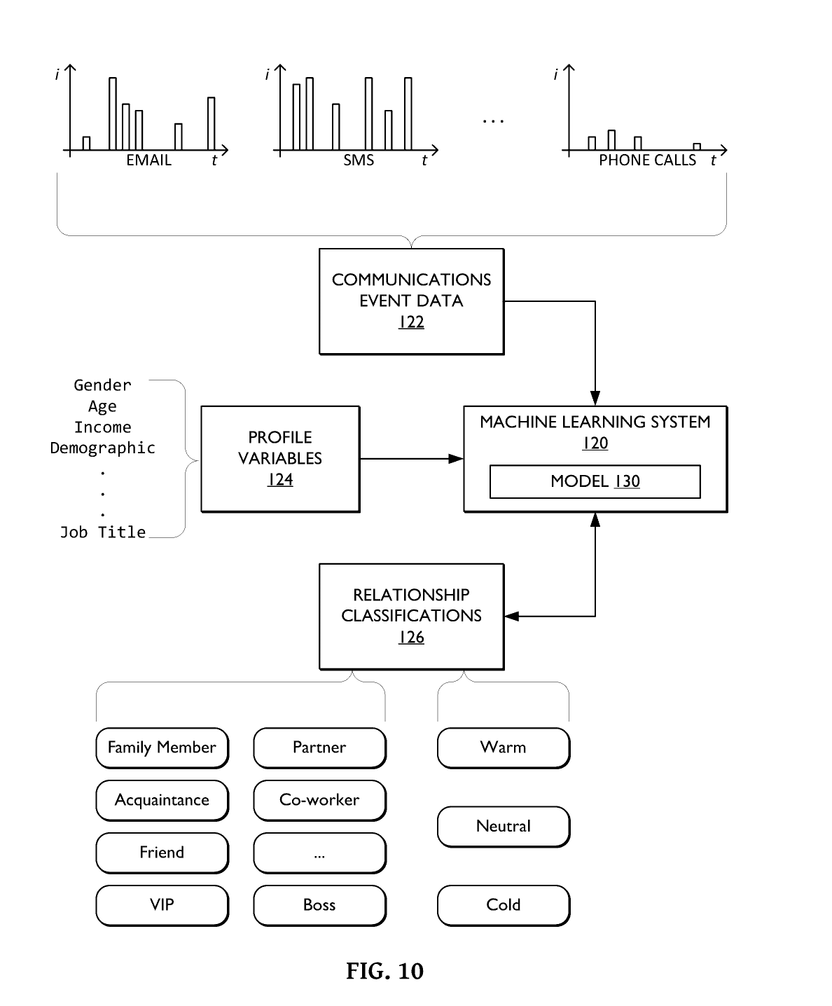

With reference to FIG. 10, a machine learning system 120 for computing total connection values is shown. The machine learning system 120 can be used to realize the scoring engine 52 of FIG. 4 and/or steps 92, 98 in the process of FIG. 6. The machine learning system 120 can replace or supplement the communications event weighting techniques discussed above. When supplementing the communications event weighting techniques, the machine learning system 120 can use the communications event weightings discussed above as initial or baseline values for a communications-behavior model.

The machine learning system 120 takes as input communications event data 122, profile variables 124, and relationship classifications 126. The machine learning system 120 is also configured to output relationship classifications 126. The machine learning system 120 can implement logistic regression, a support vector machine, a neural network, a combination of such, or similar.

Communications event data 122 represents time-based communications events, such as email messages, SMS messages, phone calls, social media interactions, and similar discussed throughout this disclosure. Communications event data 122 can be stored as quantity, i, over time, t, where quantity can be messages per unit time, phone call duration per unit time, and similar. Communications event data 122 can be used directly by the machine learning system 120. Alternatively or additionally, the machine learning system 120 can be configured to perform feature extraction on the communications event data 122 to obtain feature variables. Feature extraction can include determining frequencies, interval distributions, amplitudes, or similar.

Profile variables 124 are data about the particular searching user and can include or be derived from user profile data 30 discussed above.

Relationship classifications 126 can include a relationship type of the contact, a total connection value, or both. The relationship type can be selectable from a set that includes elements such as family member, friend, etc. The total connection value can be a label (e.g., “warm”), numerical value, or similar, which defines the strength of the relationship. The relationship classifications 126 can be mapped to connection values for computation of total connection value for a path. For example, “family member” may be assigned a value of 10, friend a value of 5, and so on. Similarly, the total connection value labels can map to numerical values. Relationship classifications 126 can be predefined and not configurable by the user.

The machine learning system 120 receives communications event data 122 continually as the user's device is operated. Similarly, the machine learning system 120 has access to the profile variables 124 in their present state and as they are updated. The machine learning system 120 takes relationship classifications 126 as training input and further outputs relationship classifications 126 after training.

The machine learning system 120 is configured to generate a model 130 of the user's communications behavior. This is advantageous because certain users may communicate in certain ways with their close contacts and in other ways with acquaintances and weaker contacts. For instance, one user may consider SMS messages to be an intimate form of communications, whereas another user may reserve phone calls for their closest contact. Hence, the profile system 20 can trigger generation and storage of a communications-behavior model 130 for each user, so that more accurate pathways from searching users to target users can be determined.

In operation, the machine learning system 120 trains the model 130 by referencing the available communications event data 122 and profile variables 124 and by requesting or inferring relationship classifications 126. For example, adding a contact to a user's VIP list in a contacts app can trigger the machine learning system 120 to update the relationship classifications 126 by adding the relationship type of “VIP” to the contact. In another example, the machine learning system 120 may periodically prompt the user to assign a relationship classification 126 to a contact, such as when the user is viewing that contact in their contacts app. After or in parallel with training, as communications event data 122 are received, the machine learning system 120 references the model 130 to assign relationship classifications 126 to contacts. In addition, the machine learning system 120, contacts app, and profile system 20 as a whole can be configured to allow users to assign relationship classifications 126 as they see fit.

Regarding operation of the machine learning system 120, re-learning and refinement of the model 130 can be performed periodically by requesting relationship classifications 126 from users. That is, training of the model 130 can be configured to occur periodically, so as to gradually improve the model 130 over time.

With reference to the profile system 20 of FIG. 4, the scoring engine 52 can be configured to implement the machine learning system 120 to train and maintain communications-behavior models 130 for the users of the profile system 20. The query engine 56 can be configured to reference the communications-behavior models 130 when calculating total connection values for paths between such users.

Hence, the machine learning system 120 can provide user-specific communications-behavior models 130 to various users of the profile system 20, so that total connection values for paths between users are more accurately computed and that the particular communications behaviors of the seeking, intermediate, and target users are taken into account when recommending that a searching user initiate contact to a target user via a recommended intermediate user.

The techniques discussed above advantageously allow the recommendation of intermediate users to a searching user for facilitating an introduction to a target user. Different types of interactions can be accounted for with different weights or with machine learning. Reciprocity of communications can also be calculated, as can recency and frequency of communications. The techniques also consider the intimacy of communications and various different types of contact information shared. This can improve computational efficiency and reduce the waste of computer resources when connecting users. It is a further advantage that the profile system transcends disparate social data systems and communications systems to provide indications of overall relationship strength, which can be used to recommend connection paths when making new relationships.

While the foregoing provides certain non-limiting example embodiments, it should be understood that combinations, subsets, and variations of the foregoing are contemplated. The monopoly sought is defined by the claims.

What is claimed is:

1. A method of finding a user profile in a computer system, the method comprising:
updating a graph database by referencing at least one user profile database that stores a plurality of user profiles and that defines relationships among the plurality of user profiles, each user profile containing data about a user, the graph database representing the plurality of user profiles as nodes and representing relationships among the plurality of user profiles as edges;
assigning connection properties to edges between pairs of nodes of pairs of respective users profiles of respective users based on at least one of a communications event between the respective users and contact information shared between the respective users;
calculating at least one total connection value for a path of edges between a searching node associated with a searching user profile and a target node associated with a target user profile;
selecting an intermediate node connected to edges of the path; and
outputting an indication of an intermediate user profile associated with the intermediate node.

2. The method of claim 1, further comprising:
assigning different contact information weights to different types of contact information;
detecting contact information of other users in the plurality of user profiles;
calculating the connection properties as relationship properties of the edges with reference to the contact information weights; and
using at least one of the relationship properties to calculate the at least one total connection value.

3. The method of claim 2, further comprising:
assigning different communications weights to different types of communications events;
detecting communications events between the plurality of users;
calculating the connection properties as engagement properties of the edges with reference to the communications weights; and
using at least one of the engagement properties to calculate the at least one total connection value.

4. The method of claim 3 comprising calculating the connection properties as relationship properties and engagement properties of the edges with reference to the communications weights.

5. The method of claim 1, wherein two edges connect two nodes in two directions, each of the two edges having an independent connection property.

6. The method of claim 1, wherein the searching user profile does not have a relationship with the target user profile and wherein the searching user profile has a relationship with the intermediate user profile.

7. The method of claim 1, comprising:
calculating a plurality of total connection values for a plurality of different paths of edges between the searching node and the target node;
selecting a plurality of intermediate nodes, each intermediate node of the plurality of intermediate nodes connected to edges of a path of the plurality of paths; and
outputting at least one indication of a plurality of intermediate user profiles associated with the plurality of intermediate nodes.

8. The method of claim 1, wherein calculating the at least one total connection value comprises referencing a machine learning model of communication behavior.

9. A method of finding a user profile from a computer system, the method comprising using a graph database to represent a plurality of user profiles as nodes and to represent relationships among the plurality of user profiles as edges, and outputting an indication of an intermediate node based on path length in response to a request to connect a searching node to a target node.

10. A system for finding a user profile from a computer system, the system comprising:
a correlation engine configured to update a graph database with reference to at least one user profile database that stores a plurality of user profiles and that defines relationships among the plurality of user profiles, each user profile containing data about a user, the graph database representing the plurality of user profiles as nodes and representing relationships among the plurality of user profiles as edges, the correlation engine further configured to assign connection properties to edges between pairs of nodes of pairs of respective users profiles of respective users based on at least one of a communications event between the respective users and contact information shared between the respective users;
a query engine configured to calculate at least one total connection value for a path of edges between a searching node associated with a searching user profile and a target node associated with a target user profile, the query engine further configured to select an intermediate node connected to edges of the path; and
a presentation engine configured to output an indication of an intermediate user profile associated with the intermediate node.

11. The system of claim 10, further comprising a scoring engine configured to assign different contact information weights to different types of contact information, detect contact information of other users in the plurality of user profiles, and calculate the connection properties as relationship properties of the edges with reference to the contact information weights, wherein the correlation engine is configured to use at least one of the relationship properties to calculate the at least one total connection value.

12. The system of claim 11, wherein the scoring engine is further configured to assign different communications weights to different types of communications events, detect communications events between the plurality of users, calculate the connection properties as engagement properties of the edges with reference to the communications weights, wherein the correlation engine is configured to use at least one of the engagement properties to calculate the at least one total connection value.

13. The system of claim 12, wherein the scoring engine is further configured to calculate the connection properties as relationship properties and engagement properties of the edges with reference to the communications weights.

14. The system of claim 10, wherein two edges connect two nodes in two directions, each of the two edges having an independent connection property.

15. The system of claim 10, wherein the searching user profile does not have a relationship with the target user profile and wherein the searching user profile has a relationship with the intermediate user profile.

16. The system of claim 10, wherein the query engine is configured to calculate a plurality of total connection values for a plurality of different paths of edges between the searching node and the target node and to select a plurality of intermediate nodes, each intermediate node of the plurality of intermediate nodes connected to edges of a path of the plurality of paths, and wherein the presentation engine is configured to output at least one indication of a plurality of intermediate user profiles associated with the plurality of intermediate nodes.

17. The system of claim 10, further comprising a scoring engine configured to train a machine learning model of communication behavior, wherein the query engine is configured to calculate the at least one total connection value referencing the machine learning model of communication behavior.
